(19) United States
(12) Patent Application Publication
(10) Pub. No.: US 2014/0075142 A1
(43) Pub. Date: Mar. 13, 2014

(54) MANAGING BACKING OF VIRTUAL MEMORY

(71) Applicants: David Hom, Poughkeepsie, NY (US); James H. Mulder, Poughkeepsie, NY (US); Mariama Ndoye, Poughkeepsie, NY (US); Michael G. Spiegel, Monroe, NY (US); Elpida Tzortzatos, Lagrangeville, NY (US)

(72) Inventors: David Hom, Poughkeepsie, NY (US); James H. Mulder, Poughkeepsie, NY (US); Mariama Ndoye, Poughkeepsie, NY (US); Michael G. Spiegel, Monroe, NY (US); Elpida Tzortzatos, Lagrangeville, NY (US)

(73) Assignee: INTERNATIONAL BUSINESS MACHINES CORPORATION, Armonk, NY (US)

(21) Appl. No.: 13/615,377

(22) Filed: Sep. 13, 2012

(51) Int. Cl. G06F 12/00

(52) U.S. Cl. 711/170; 711/E12.002

(57) ABSTRACT

A computer system includes memory and a processor configured to manage memory allocation. The processor is configured to execute a memory allocation request to allocate a portion of the memory to an application by determining whether a size of the memory allocation request is less than a first pre-defined size. The processor searches virtual memory for a free allocated memory area corresponding at least to the size of the memory allocation request based on determining that the size of the memory allocation request is less than the first pre-defined size.

### BACKGROUND

The present disclosure relates to managing the backing of virtual memory with real memory, and in particular to selectively varying sizes of real memory to back virtual memory and selectively freeing and re-allocating memory that has been previously allocated.

Real storage manager (RSM) routines administer the use of real storage and direct the movement of virtual pages between auxiliary storage and real storage. The RSM routines make all addressable virtual storage appear as real or physical storage to a user, while only the virtual pages necessary for execution are kept in real storage.

The RSM assigns real storage frames on request from a virtual storage manager (VSM), which manages the allocation of virtual storage pages, and the RSM determines a size of memory that will be allocated to back a virtual storage page. Examples of memory backing sizes include 4 kbytes and 1 Mbyte. Software applications using larger segments of virtual storage, such as multiple Mbytes, can achieve measurable performance improvement if these segments are backed by larger page frames in real memory, such as the 1 Mbyte page frame. Typically, operating systems back virtual storage with only one size of memory backing, inhibiting a dynamic response to real storage demands of a system.

### SUMMARY

Exemplary embodiments include a computer system including memory and a processor. The processor is configured to execute a memory allocation request to allocate a portion of the memory to an application by determining whether a size of the memory allocation request is less than a first pre-defined size. The processor is further configured for searching virtual memory for a free allocated memory area corresponding at least to the size of the memory allocation request based on determining that the size of the memory allocation request is less than the first pre-defined size.

Additional exemplary embodiments include a computer program product includes a computer readable storage medium having computer readable instructions stored thereon that, when executed by a processing unit implements a method. The method includes receiving a memory allocation request to allocate a portion of virtual memory and back the portion of the virtual memory with real memory and determining whether a size of the memory allocation request is less than a first pre-defined size. The method further includes searching virtual memory for a free allocated memory area corresponding at least to the size of the memory allocation request based on determining that the size of the memory allocation request is less than the first pre-defined size.

Further exemplary embodiments include a computer-implemented method including receiving a memory allocation request to allocate a portion of virtual memory and back the portion of the virtual memory with real memory and determining whether a size of the memory allocation request is less than a first pre-defined size. The method further includes searching virtual memory for a free allocated memory area corresponding at least to the size of the memory allocation request based on determining that the size of the memory allocation request is less than the first pre-defined size.

Further exemplary embodiments include a computer-implemented method, including receiving a request to free a block of allocated memory to generate a freed block of allocated memory and comparing the freed block of allocated memory to a first pre-defined size and a second pre-defined size. The method further includes initializing page table entries corresponding to second pre-defined sized blocks of the freed block of allocated memory based on determining that the freed block of allocated memory is smaller than the first pre-defined size and larger than the second pre-defined size.

Additional features and advantages are realized by implementation of embodiments of the present disclosure. Other embodiments and aspects of the present disclosure are described in detail herein and are considered a part of the claimed invention. For a better understanding of the embodiments, including advantages and other features, refer to the description and to the drawings.

### BRIEF DESCRIPTION OF THE SEVERAL VIEWS OF THE DRAWINGS

The subject matter which is regarded embodiments of the present disclosure is particularly pointed out and distinctly claimed in the claims at the conclusion of the specification. The forgoing and other features, and advantages of the embodiments are apparent from the following detailed description taken in conjunction with the accompanying drawings in which:

FIG. 1 illustrates a block diagram of a storage management system according to one embodiment of the present disclosure;

FIG. 2 illustrates a block diagram of a method according to one embodiment;

FIG. 3 illustrates a flow diagram of a method according to one embodiment;

FIG. 4 illustrates a flow diagram of a method according to another aspect of the embodiments;

FIG. 5 illustrates a flow diagram of a method according to another aspect;

FIGS. 6A and 6B illustrate a flow diagram of a method according to yet another aspect of the embodiments;

FIG. 7 illustrates a computer system according to one embodiment;

FIG. 8 illustrates a computer system according to another embodiment; and

FIG. 9 illustrates a computer-readable medium according to one embodiment.

### DETAILED DESCRIPTION

Supporting virtual memory allocation of segments in virtual memory having varying sizes with only one size frame in real memory reduces the ability of a system to dynamically respond to real storage demands of the system. Disclosed embodiments relate to supporting virtual memory allocations with multiple page frame sizes in real memory and freeing and re-allocating previously-allocated memory.

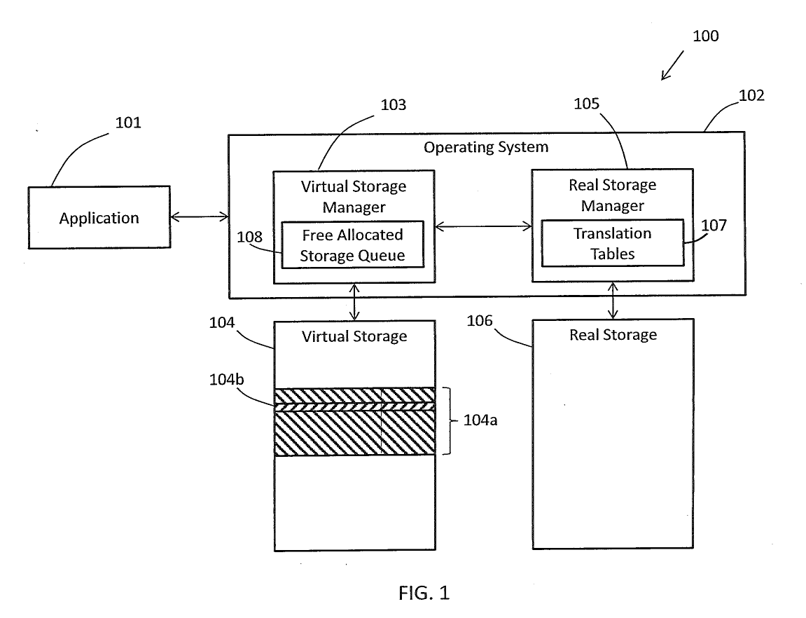

FIG. 1 is a block diagram of a memory allocation system 100 according to an embodiment of the present disclosure. The system 100 includes an application 101 and an operating system (O/S) 102. The operating system includes a virtual storage manager (VSM) 103 configured to manage virtual storage 104, and a real storage manager (RSM) 105 configured to manage real storage. The application 101 may be any type of application comprising program code that is executed on a computer to cause the computer to perform various functions, including calculations, storage, reading from storage, display, or any other functions. Virtual storage 104 may be in the form of tables having virtual addresses and the VSM 103 may maintain information regarding the addresses, such as whether the addresses are allocated for use by the application 101 or operating system 102, or whether the addresses are free to be allocated. As the application 101 runs, memory may need to be allocated to the program to perform certain functions. The VSM 103 assigns or allots virtual memory to the application 101 in pre-defined segment sizes. In embodiments of the present disclosure, the pre-defined segment sizes may correspond to any pre-defined segment size, such as 8 bytes, 4 kbytes, 1 Mbyte, or any other pre-defined size, according to the design considerations of the O/S 102.

The VSM 103 communicates with the RSM 105 to back the assigned virtual memory segments with memory segments in real storage 106. The virtual memory segments may be backed by any segment sizes in real storage 106, although for purposes of description, embodiments of the present disclosure will address a system that selectively backs assigned segments of virtual storage 104 with segments of 4 kbytes or 1 Mbyte in real storage 106.

The RSM 105 determines a size of a segment in real storage 106 to back allocated virtual storage 104 based on design considerations of the system 100, such as available memory, types of applications, types of memory, the size of the allocated memory segment, or any other considerations for controlling a size of backing memory. The RSM 105 backs the allocated segments of virtual storage 104 with segments of real storage 106 that may not necessarily correspond to the locations in virtual storage 104. For example, if 1 MB of consecutive addresses are allotted in virtual storage 104, 1 MB of non-consecutive addresses may be designated by the real storage manager 105 to back the allotted segment in virtual storage 104. The RSM 105 may maintain one or more translation tables 107 including segment tables and page tables to provide the O/S 102 and the application 101 with data stored in real storage 106 corresponding to requests from the O/S 102 and application 101 to access corresponding virtual addresses.

In FIG. 1, block 104a represents a large page (such as 1 MB) of virtual storage 104 allocated to the application 101 based on a request by the application 101. Block 104b represents a small page (such as 4 kb) of virtual storage 104 that is freed by the application 101 and re-allocated by the VSM 103. In embodiments of the present disclosure, memory allocated by the VSM 103 may be backed by multiple discrete sizes of segments of real storage 106. In the description to follow, the terms “large” and “small” with reference to pages or frames refer to two pre-defined and distinct sizes of memory, such as 1 MB and 4 kbytes, respectively. Described embodiments of the present disclosure encompass systems having a small number of sizes real memory to back virtual memory, such as two, three, or four distinct sizes. For example, in one embodiment, a pre-defined “large” size corresponds to a size of memory accessible by a segment table of the RSM 105, and the pre-defined “small” size corresponds to a size of memory accessible by the combination of the segment table and a page table of the RSM 105. The use of translation tables 107, including segment tables, page tables, and offsets, is known in the art and is not described in detail in the present disclosure. However, it is understood that embodiments of the present disclosure encompass systems utilizing any number of discrete, pre-defined and finite number of sizes of real storage 106 to back allocated segments of virtual storage 104.

In embodiments of the present disclosure, once a block, such as block 104b, is freed by an application within a portion of virtual memory allocated by the VSM 103, the VSM 103 may determine whether the freed block corresponds to a pre-defined block size corresponding to a backing size used by the RSM 105, such as a pre-defined “small” block size. For example, if the RSM 105 backs segments of allocated virtual storage 104 by either 4 kb blocks or 1 MB blocks in real storage 106, the VSM 103 may detect whether at least 4 kb of virtual storage 104 within an allocated block, such as block 104a, has been freed by an application. When it is determined that the block of the pre-defined size has been freed, the VSM 103 may store the address of the block in a free allocated storage queue 108 along with information indicating that the block 104b is of a size corresponding to the pre-defined “small” block size. The VSM 103 may provide the RSM 105 with the virtual address of the freed block of the pre-defined “small” size. In a subsequent allocation operation, the RSM 105 may back a segment of virtual storage 104 with the real storage 106 location corresponding to the address of the freed “small” block 104b, and the VSM 103 may then remove the address of the block from the free allocated storage queue 108.

Conversely, if the VSM 103 determines that the block 104b is not as large as the pre-defined “small” storage size, the VSM 103 may store the block 104b information without indicating that the block 104b corresponds to the pre-defined “small” size. In subsequent memory-freeing operations, the VSM 103 may determine whether the block 104b is directly adjacent to other freed blocks, and may determine whether the combination of adjacent freed blocks corresponds to pre-defined sizes of memory segments, corresponding to the sizes utilized by the system to back virtual storage 104 with real storage 106.

In another example, the block 104a may correspond to multiple megabytes of allocated storage, and the block 104b may correspond to at least 1 MB of allocated storage. In such an embodiment, the VSM 103 may determine that a pre-defined “large” segment of memory has been freed (i.e. 1 MB) and may de-allocate the block 104b. The VSM 103 may provide information regarding the block 104b to the RSM 105, and the RSM 105 may reset segment table entries corresponding to the block 104b.

Accordingly, the system 100 may manage virtual storage 104 blocks of different sizes, may manage pre-defined “small” blocks of allocated virtual storage 104 within pre-defined “large” allocated blocks, and may back blocks of virtual storage 104 with frames of varying sizes in real storage 106. The system 100 may determine whether freed blocks in virtual storage 104 correspond to pre-defined storage sizes and may de-allocate and re-allocate the blocks accordingly.

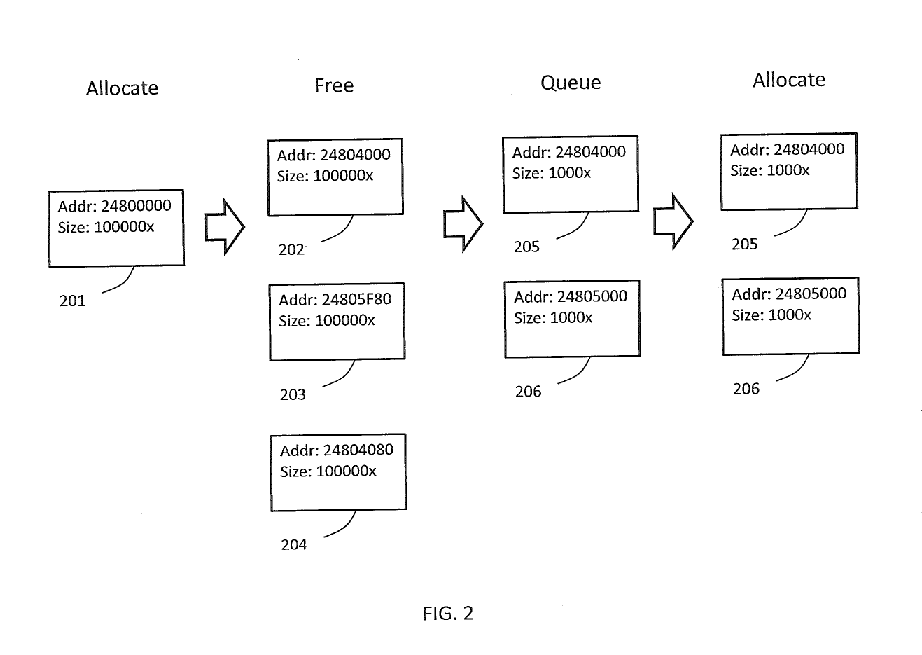

FIG. 2 illustrates an example of allocating and freeing storage of varying sizes according to one embodiment. In the embodiment of FIG. 2, the system backs storage in a pre-defined “small” size of 4 kbytes and a pre-defined “large” size of 1 MB. An application may request that a large page be allocated in virtual storage and backed by a large frame in real memory. A virtual storage manager (VSM) requests from a real storage manager (RSM) that 1 MB of storage be backed by a large frame. The VSM allocates a storage area having a size of 1 MB (100000×) at address 24800000, represented by block 201. Blocks 202, 203 and 204 represent an application freeing segments of storage. Block 202 represents the application freeing 128 bytes (80×) of storage at address 2480400. Block 203 represents the application freeing 128 bytes (80×) of storage at address 24805F80. Block 204 represents the application freeing 7936 bytes (1F00x) of storage at address 24804080.

The VSM recognizes that two blocks, each having 4 kbytes (1000×) of storage, are freed at addresses 24804000 and 24805000, respectively. The VSM adds the two blocks to a queue for free allocated data blocks, and may transmit to the RSM the addresses of the freed data blocks. The RSM may perform any cleanup needed if the storage is backed by 4 kbyte frames in real memory.

If an application then requests 8 kbytes of storage to be allocated, the VSM may allocate the two blocks located in the free allocated data block queue, starting at addresses 24804000 and 24805000.

Accordingly, as illustrated in FIG. 2, embodiments of the present disclosure encompass detecting pre-defined sizes of freed memory and making the pre-defined sizes of freed memory available for re-allocation by a memory management system.

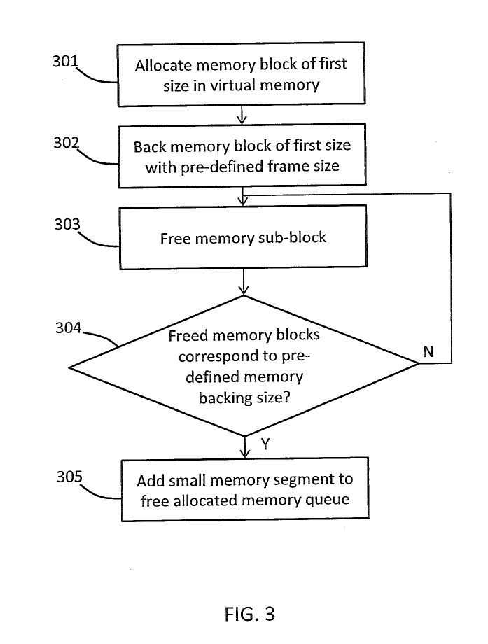

FIG. 3 illustrates a flowchart of a method according to an embodiment of the present disclosure. In block 301, a memory block of a first size is allocated in virtual memory, and in block 302, the memory block is backed by a pre-defined frame size in real memory.

In block 303, a sub-block of memory within the allocated memory of block 301 is freed in virtual memory. The sub-block of freed memory may correspond to a segment within the range of the allocated large frame. For example, a program or operating system may instruct a virtual storage manager to free the smaller block of memory within the range of the allocated large frame.

In block 304, it is determined whether the sub-block of freed memory corresponds to a pre-defined memory backing size, or pre-defined frame size. The pre-defined frame size may correspond to the pre-defined sizes in which the system backs virtual memory with real memory. In one embodiment, a system may back virtual memory with real memory in segments of 1 MB and 4 kbytes, corresponding to address blocks accessible by segment tables (1 MB) and a combination of segment tables and page tables (4 kbytes), respectively. However, embodiments of the present disclosure encompass any pre-defined frame sizes. The segment of freed memory blocks may be contiguous memory blocks in virtual storage, or contiguous memory addresses.

If it is determined in block 304 that the freed allocated memory blocks correspond to the pre-defined frame size, the addresses of the memory blocks maybe stored in a free allocated memory queue in block 305. The queue may be used by the VSM and the RSM to allocate memory in the pre-defined blocks.

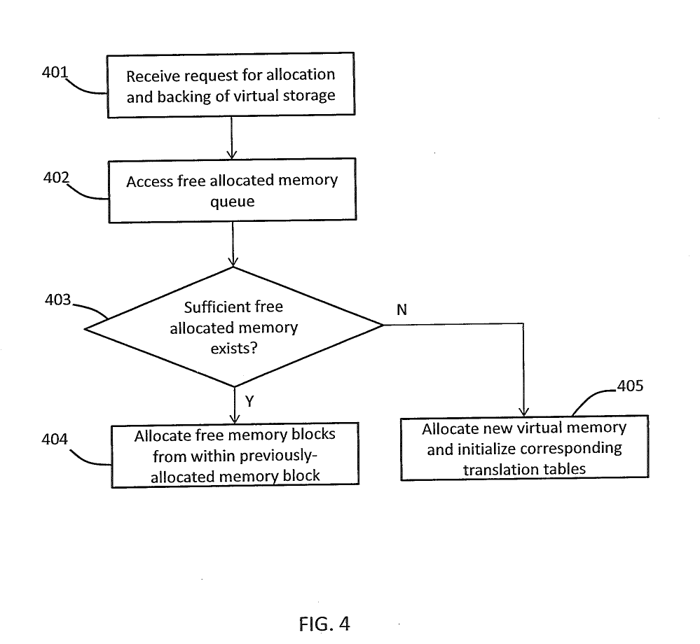

FIG. 4 illustrates a process of allocating memory and backing the allocated virtual memory by pre-defined blocks of real memory. In block 401, a request is received to allocate a block of virtual storage and back the virtual storage with frames of a pre-defined size in real storage. For example, an application may provide to a VSM a request to allocate storage and the VSM send a request to an RSM to back the allocated virtual storage by frames of the pre-defined size. In block 402, the free allocated memory queue is accessed to determine whether any previously allocated blocks of memory sufficiently large to accommodate the allocation request is free to be re-allocated.

In block 403, it is determined whether a block of free allocated memory in the allocated memory queue exists that is of a sufficient size to accommodate the request of block 401. If a block of memory of a sufficient size exists in the free allocated memory, then the block of memory is allocated in block 404 to accommodate the request, and the memory is backed by a pre-defined frame size.

On the other hand, if it is determined in block 403 that insufficient free allocated memory exists to accommodate the request of block 401, then new virtual memory is allocated in block 405 to accommodate the request, and translation tables are initialized to correspond to the newly-allocated memory.

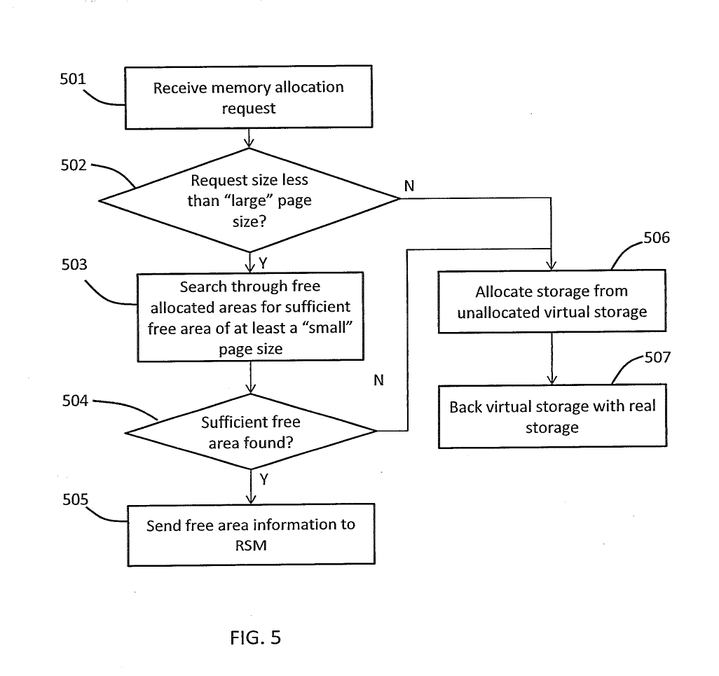

FIG. 5 illustrates a flow diagram of a method of requesting allocation of data storage according to another aspect of the embodiments. In block 501, a memory allocation request is received. When the memory allocation request is received, a virtual storage manager (VSM) may allocate a sufficient number of pages in virtual memory to accommodate the request, and a real storage manager (RSM) may back the pages with frames in real memory based on the storage design and requirements of the system. The RSM may back the pages in virtual memory with segments, or frames, in real memory of varying sizes. In one embodiment, the frames may be either small frames or large frames, and in one exemplary embodiment the small frames are 4 kbytes and the large frames are 1 MB. The memory allocation may be requested by an application, middleware, or O/S running on a computer system.

In block 502, the size of the request is determined. For example, in a system in which a real storage manager (RSM) may back a virtual storage segment by a small frame of real storage, such as 4 kbytes or a large frame, such as 1 MB, the VSM may determine whether the allocation request corresponds to a segment of virtual memory equal to or greater than a pre-defined large page size, such as 1 MB. If it is determined that the request size is less than the large page size, free allocated areas corresponding to virtual memory backed by large frames are searched in block 503 to determine whether sufficient free area exists in blocks of at least a small page size, such as 4 kbytes, to accommodate the request. For example, the VSM may perform the searching of the free allocated areas in the virtual memory.

In block 504, if it is determined that a sufficiently-large segment of free allocated memory exists in the virtual memory, information regarding the free area is sent to the RSM in block 505. For example, if an allocated segment of virtual memory has been backed by 1 MB of real memory, the VSM may search through the portion of virtual memory corresponding to the allocated segment to determine whether an area or block of memory exists within the allocated segment having a size sufficient to accommodate the allocation request. In particular, the free area may comprise a contiguous number of small-page-sized blocks sufficient to accommodate the allocation request. In one embodiment in which the small pages correspond to 4 kbyte pages, the VSM may search for contiguous blocks of at least 4 kbytes that are free within allocated memory.

If a sufficiently large block of free virtual memory exists that represents at least one entire small page, the VSM may send information regarding the free area to the RSM in block 505, and the RSM may initialize page table entries for the pages if the segment is backed by 4 kbyte pages.

On the other hand, if it is determined in block 502 that the request size corresponding to the allocation request is equal to, or greater than, the pre-defined large page size, the VSM may allocate storage from unallocated virtual storage in block 506, and the RSM may back the storage with a requested backed storage size in block 507. In addition, if it is determined in block 504 that insufficient free allocated memory exists in block 504, then the VSM may allocate storage from unallocated virtual storage in block 506, and the RSM may back the storage with a requested backed storage size in block 507.

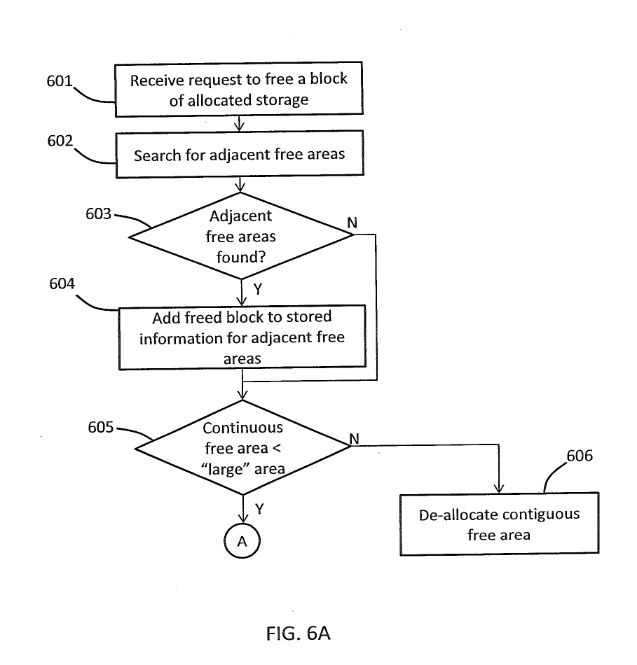

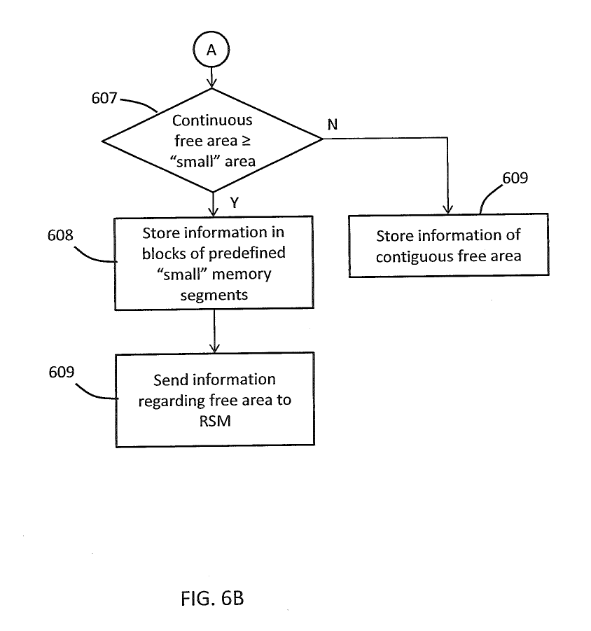

FIGS. 6A and 6B illustrate a method of freeing allocated memory according to one embodiment. In block 601, a request is received to free a block of allocated storage. In one embodiment, an application or O/S provides a request to a VSM to free virtual memory that had previously been allocated to the application or O/S. In block 602, areas adjacent to the block that is requested to be freed are searched to determine whether adjacent blocks include free allocated memory. In one embodiment, the VSM performs the search of the adjacent virtual memory for free memory.

If adjacent free areas are found in block 603, then the freed block of virtual memory is combined with the adjacent free areas in block 604. For example, in one embodiment, the VSM includes descriptor queue elements (DQE), which correspond to already-allocated areas of virtual storage in an address space, and free queue elements (FQE), which correspond to free areas within the already-allocated memory space. The adjacent free areas correspond to areas that had been freed prior to receiving the request in block 601 and corresponded to pre-existing FQEs. The VSM may search the FQE's for adjacent free storage, and if the adjacent free storage is found, the freed block of memory is combined with the adjacent free FQEs.

In block 605, it is determined whether the contiguous free area corresponding to the freed block and any adjacent free areas forming a contiguous free area are smaller in size than a pre-defined “large” area. For example, in one embodiment, the pre-defined large area is 1 MB of storage. If the free area is greater-than-or-equal-to the pre-defined large area, then the free area is de-allocated in block 606. In other words, in an embodiment in which the VSM includes DQE's corresponding to already-allocated areas, the free area is disassociated from the DQE's, and the VSM may signal the real storage manager (RSM) to reset a segment table entry corresponding to the free area and release the real storage associated with the freed area.

Referring to FIG. 6B, which is continued from FIG. 6A as indicated by the reference letter “A”, if it is determined in block 605 that the contiguous free area is less than the pre-defined large area, then it may further be determined in block 607 whether the free area is greater than, or equal to, a pre-defined “small” area. For example, in an embodiment in which virtual memory is backed by segments of real memory in blocks of 4 kbytes and 1 MB, the “small” area may be 4 kbytes, and the VSM may determine whether the free area includes a contiguous 4 kbyte block. If it is determined that the free area includes a block that is at least equal to the pre-defined small area, information about the pre-defined small segments is stored in block 608 and may be transmitted to the RSM in block 609 for cleaning up translation tables associated with the pre-defined small segments that are backed by small segments of real memory. For example, if the pre-defined small segments are 4 kbytes, then the VSM may build FQEs corresponding to each 4 kbyte block. These FQEs may not be associated with DQE's, but may be supplied to the RSM in block 609 to allow for page table cleanup of entries corresponding to the freed FQEs.

On the other hand, if it is determined in block 607 that the free area is less than the pre-defined small area, then information about the free area is stored by the VSM in block 609. For example, an FQE may be built corresponding to the free area and may be queued to an associated DQE.

Accordingly, embodiments of the present disclosure enable managing of memory blocks of various sizes in virtual memory and backed by real storage of varying sizes. It is understood that embodiments of the present disclosure encompass systems having a discrete and finite number of pre-defined memory blocks with which virtual memory is backed by real memory. In embodiments of the present disclosure, memory segments within allocated memory blocks may be freed and re-allocated in later operations to be backed by memory blocks of different sizes. Accordingly, the system may dynamically manage memory storage within the system.

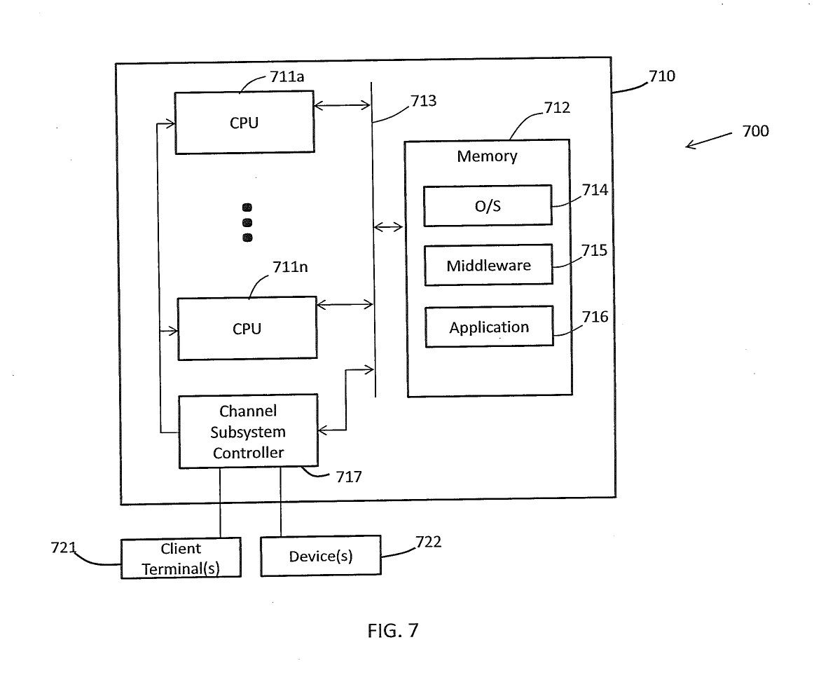

Embodiments of the present disclosure encompass any type of computer system capable of managing memory. FIG. 7 illustrates a computer system 700 according to one embodiment of the present disclosure. The computer system 700 may correspond to a mainframe-type computer system in which multiple client terminals may access the mainframe computer and may be managed by the mainframe computer.

The system 700 includes a host computer 710. The host computer 710 includes one or more CPUs 711a-711n configured to access memory 712 via a bus 713. Memory 712 may store an operating system 714, middleware 715, and applications 716. A channel subsystem controller 717 may access external devices, such as client terminals 721 and other devices 722, including printers, display devices, storage devices, I/O devices, or any other device capable of communication with the host computer 710. In some embodiments, as each client terminal 721 accesses the host computer 710, one or more CPUs 711a-711n may be designated to correspond to the client terminal 721, and instances of the O/S 714, middleware 715, and applications 716 may be opened to interact with separate client terminals 721, such as by creating virtual computers corresponding to each client terminal 721 within the host computer 710.

In some embodiments of the present disclosure, the O/S 714 stores information for controlling the VSM and RSM to manage memory 710 according to the above-described embodiments.

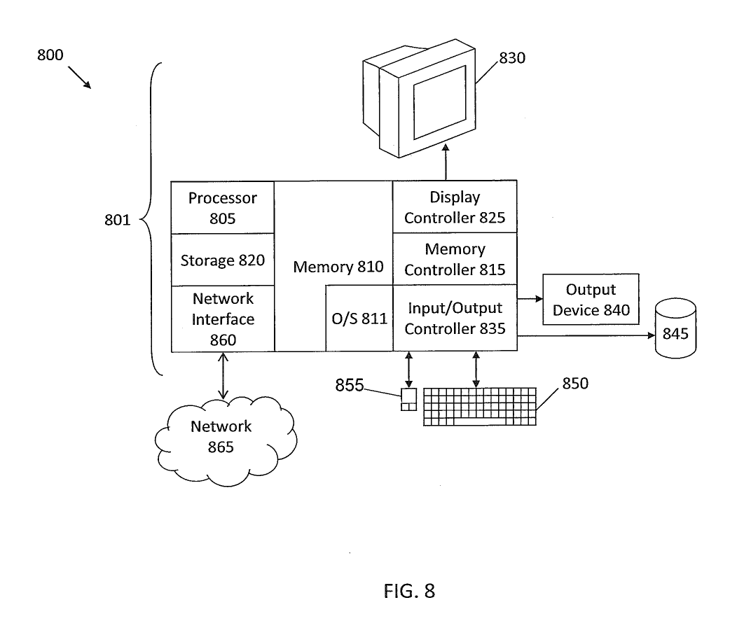

FIG. 8 illustrates a block diagram of a computer system 800 according to another embodiment of the present disclosure. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 800 therefore may include general-purpose computer or mainframe 801 capable testing a reliability of a base program by gradually increasing a workload of the base program over time.

In an exemplary embodiment, in terms of hardware architecture, as shown in FIG. 8, the computer 801 includes a one or more processors 805, memory 810 coupled to a memory controller 815, and one or more input and/or output (I/O) devices 840, 845 (or peripherals) that are communicatively coupled via a local input/output controller 835. The input/output controller 835 can be, for example, one or more buses or other wired or wireless connections, as is known in the art. The input/output controller 835 may have additional elements, which are omitted for simplicity in description, such as controllers, buffers (caches), drivers, repeaters, and receivers, to enable communications. Further, the local interface may include address, control, and/or data connections to enable appropriate communications among the aforementioned components. The input/output controller 835 may include a plurality of sub-channels configured to access the output devices 840 and 845. The sub-channels may include, for example, fiber-optic communications ports.

The processor 805 is a hardware device for executing software, particularly that stored in storage 820, such as cache storage, or memory 810. The processor 805 can be any custom made or commercially available processor, a central processing unit (CPU), an auxiliary processor among several processors associated with the computer 801, a semiconductor based microprocessor (in the form of a microchip or chip set), a macroprocessor, or generally any device for executing instructions.

The memory 810 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 810 may incorporate electronic, magnetic, optical, and/or other types of storage media. Note that the memory 810 can have a distributed architecture, where various components are situated remote from one another, but can be accessed by the processor 805.

The instructions in memory 810 may include one or more separate programs, each of which comprises an ordered listing of executable instructions for implementing logical functions. In the example of FIG. 8, the instructions in the memory 810 include a suitable operating system (O/S) 811. The operating system 811 essentially controls the execution of other computer programs and provides scheduling, input-output control, file and data management, memory management, and communication control and related services.

In an exemplary embodiment, a conventional keyboard 850 and mouse 855 can be coupled to the input/output controller 835. Other output devices such as the I/O devices 840, 845 may include input devices, for example but not limited to a printer, a scanner, microphone, and the like. Finally, the I/O devices 840, 845 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 800 can further include a display controller 825 coupled to a display 830. In an exemplary embodiment, the system 800 can further include a network interface 860 for coupling to a network 865. The network 865 can be an IP-based network for communication between the computer 801 and any external server, client and the like via a broadband connection. The network 865 transmits and receives data between the computer 801 and external systems. In an exemplary embodiment, network 865 can be a managed IP network administered by a service provider. The network 865 may be implemented in a wireless fashion, e.g., using wireless protocols and technologies, such as WiFi, WiMax, etc. The network 865 can also be a packet-switched network such as a local area network, wide area network, metropolitan area network, Internet network, or other similar type of network environment. The network 865 may be a fixed wireless network, a wireless local area network (LAN), a wireless wide area network (WAN) a personal area network (PAN), a virtual private network (VPN), intranet or other suitable network system and includes equipment for receiving and transmitting signals.

When the computer 801 is in operation, the processor 805 is configured to execute instructions stored within the memory 810, to communicate data to and from the memory 810, and to generally control operations of the computer 801 pursuant to the instructions.

In an exemplary embodiment, the methods of managing memory described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

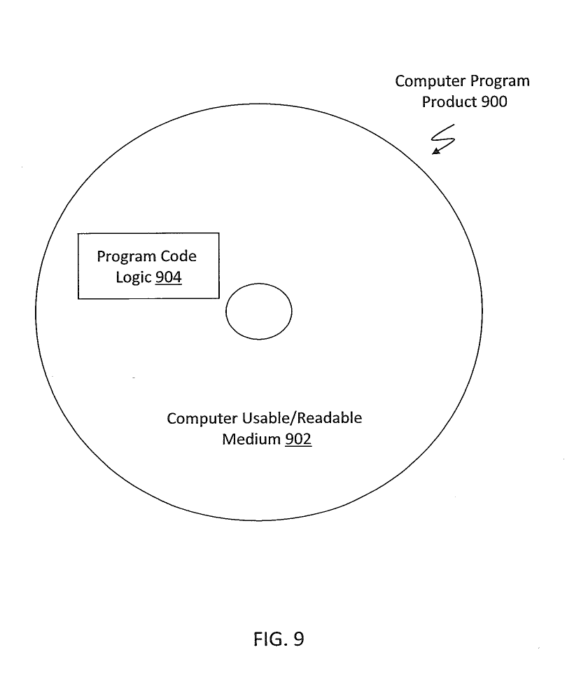

As described above, embodiments can be embodied in the form of computer-implemented processes and apparatuses for practicing those processes. An embodiment may include a computer program product 900 as depicted in FIG. 9 on a computer readable/usable medium 902 with computer program code logic 904 containing instructions embodied in tangible media as an article of manufacture. Exemplary articles of manufacture for computer readable/usable medium 902 may include floppy diskettes, CD-ROMs, hard drives, universal serial bus (USB) flash drives, or any other computer-readable storage medium, wherein, when the computer program code logic 904 is loaded into and executed by a computer, the computer becomes an apparatus for practicing the embodiments. Embodiments include computer program code logic 904, for example, whether stored in a storage medium, loaded into and/or executed by a computer, or transmitted over some transmission medium, such as over electrical wiring or cabling, through fiber optics, or via electromagnetic radiation, wherein, when the computer program code logic 904 is loaded into and executed by a computer, the computer becomes an apparatus for practicing the embodiments. When implemented on a general-purpose microprocessor, the computer program code logic 904 segments configure the microprocessor to create specific logic circuits.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention to the particular embodiments described. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosed embodiments. Many modifications and variations will be apparent to those of ordinary skill in the art without departing from the scope and spirit of the embodiments of the present disclosure.

While preferred embodiments have been described above, it will be understood that those skilled in the art, both now and in the future, may make various improvements and enhancements which fall within the scope of the claims which follow.

What is claimed is:

1. A computer system, comprising:
memory; and
a processor configured to execute a memory allocation request to allocate a portion of the memory to an application by determining whether a size of the memory allocation request is less than a first pre-defined size, and searching virtual memory for a free allocated memory area corresponding at least to the size of the memory allocation request based on determining that the size of the memory allocation request is less than the first pre-defined size.

2. The computer system of claim 1, wherein the processor is configured to back the free allocated memory area with frames of the memory having a second pre-defined size less than the first pre-defined size.

3. The computer system of claim 2, wherein searching the virtual memory for the free allocated memory area corresponding at least to the size of the memory allocation request includes searching portions of the virtual memory previously backed by blocks of the memory having the first pre-defined size.

4. The computer system of claim 2, wherein the processor is configured to execute a real storage manager (RSM) program configured to maintain translation tables including a segment table and a page table,
the first pre-defined size corresponds to a size of a block of addresses pointed to by each entry of the segment table, and
the second pre-defined size corresponds to a size of a block of addresses pointed to by each entry of the page table.

5. The computer system of claim 1, wherein the processor is configured to allocate memory from among unallocated virtual memory based on determining that the size of the memory allocation request is larger than the first pre-defined size.

6. The computer system of claim 1, wherein the processor is configured to allocate memory from among unallocated virtual memory based on determining sufficient free allocated virtual memory does not exist to accommodate the memory allocation request.

7. The computer system of claim 1, wherein the processor is further configured to receive a request to free a block of allocated virtual memory to generate a freed block of allocated virtual memory, to search for adjacent free areas to the freed block of allocated virtual memory, and to combine the freed block of allocated virtual memory to the adjacent free areas to form the free allocated memory area based on determining that the adjacent free areas exist.

8. The computer system of claim 7, wherein the processor is further configured to compare the free allocated memory area to the first pre-defined size and the second pre-defined size, to de-allocate the free allocated memory area based on determining that the size of the free allocated memory area is at least equal to the first pre-defined size, and to initialize page table entries corresponding to blocks of the free allocated memory area having a second pre-defined size based on determining that the free allocated memory area is smaller than the first pre-defined size and at least as large as the second pre-defined size.

9. A computer program product comprising:
a computer readable storage medium having computer readable instructions stored thereon that, when executed by a processing unit implements a method, comprising:
receiving a memory allocation request to allocate a portion of virtual memory and back the portion of virtual memory with real memory;
determining whether a size of the memory allocation request is less than a first pre-defined size; and
searching virtual memory for a free allocated memory area corresponding at least to the size of the memory allocation request based on determining that the size of the memory allocation request is less than the first pre-defined size.

10. The computer program product of claim 9, the method further comprising backing the free allocated memory area with frames of the real memory having a second pre-defined size less than the first pre-defined size.

11. The computer program product of claim 10, wherein searching the virtual memory for the free allocated memory area corresponding at least to the size of the memory allocation request includes searching portions of the virtual memory previously backed by blocks of the real memory having the first pre-defined size.

12. The computer program product of claim 9, the method further comprising allocating memory from among unallocated virtual memory based on determining that the size of the memory allocation request is larger than the first pre-defined size.

13. The computer program product of claim 9, the method further comprising:
receiving a request to free a block of allocated virtual memory to generate a freed block of allocated virtual memory;
searching for adjacent free areas to the freed block of allocated virtual memory; and
combining the freed block of allocated virtual memory to adjacent free areas to form the free allocated memory area based on determining that the adjacent free areas exist.

14. The computer program product of claim 13, the method further comprising:
comparing the free allocated memory area to the first pre-defined size and the second pre-defined size;
de-allocating the free allocated memory area based on determining that a size of the free allocated memory area is at least equal to the first pre-defined size; and
initializing page table entries corresponding to second pre-defined sized blocks of the free allocated memory area based on determining that the free allocated memory area is smaller than the first pre-defined size and at least as large as the second pre-defined size.

15. A computer-implemented method, comprising:
receiving, by a processor, a memory allocation request to allocate a portion of virtual memory and back the portion of virtual memory with real memory;
determining whether a size of the memory allocation request is less than a first pre-defined size; and
searching the virtual memory for a free allocated memory area corresponding at least to the size of the memory allocation request based on determining that the size of the memory allocation request is less than the first pre-defined size.

16. The method of claim 15, further comprising backing the free allocated memory area with frames of the real memory having a second pre-defined size less than the first pre-defined size.

17. The method of claim 16, wherein searching the virtual memory for the free allocated memory area corresponding at least to the size of the memory allocation request includes searching portions of the virtual memory previously backed by blocks of the real memory having the first pre-defined size.

18. The method of claim 15, further comprising allocating memory from among unallocated virtual memory based on determining that the size of the memory allocation request is larger than the first pre-defined size.

19. The method of claim 15, further comprising:
receiving a request to free a block of allocated virtual memory to generate a freed block of allocated virtual memory;
searching for adjacent free areas to the freed block of allocated virtual memory; and
combining the freed block of allocated virtual memory to adjacent free areas to form the free allocated memory area based on determining that the adjacent free areas exist.

20. The method of claim 13, further comprising:
comparing the free allocated memory area to the first pre-defined size and the second pre-defined size;
de-allocating the free allocated memory area based on determining that a size of the free allocated memory area is at least equal to the first pre-defined size; and
initializing page table entries corresponding to second pre-defined sized blocks of the free allocated memory area based on determining that the free allocated memory area is smaller than the first pre-defined size and at least as large as the second pre-defined size.

21. A computer-implemented method, comprising:
receiving, by a processor, a request to free a block of allocated memory to generate a freed block of allocated memory;
comparing the freed block of allocated memory to a first pre-defined size and a second pre-defined size; and
initializing page table entries corresponding to blocks of the freed block of allocated memory having the second pre-defined size based on determining that the freed block of allocated memory is smaller than the first pre-defined size and larger than the second pre-defined size.

22. The method of claim 21, further comprising:
de-allocating the freed block of allocated memory and initializing segment table entries corresponding to the freed block of allocated memory based on determining that the freed block of allocated memory is at least equal in size to the first pre-defined size.

23. The method of claim 21, further comprising:
storing location information about the freed block of allocated memory based on determining that the freed block of allocated memory is smaller than each of the first pre-defined size and the second pre-defined size.

24. The method of claim 21, further comprising:
searching memory around the freed block of allocated memory for adjacent areas of freed allocated memory; and
combining the freed block of allocated memory with the adjacent areas of freed allocated memory based on determining that the adjacent areas of freed allocated memory exist.
